(19) United States
(12) Patent Application Publication
(10) Pub. No.: US 2003/0090763 A1
(43) Pub. Date: May 15, 2003

(54) Echelle grating interleaver

(75) Inventors: Zhicheng Yang, Burnsville, MN (US); Qi Wang, Burnsville, MN (US); Boying Barry Zhang, Lawrenceville, NJ (US)

Correspondence Address: ALTERA LAW GROUP, LLC, 6500 CITY WEST PARKWAY, SUITE 100, MINNEAPOLIS, MN, 55344-7704, US

(73) Assignee: ADC Telecommunications, Inc., Eden Prairie, MN (US)

(21) Appl. No.: 10/010,647

(22) Filed: Nov. 13, 2001

(51) Int. Cl. H04J 14/02

(52) U.S. Cl. 359/130; 359/124

(57) ABSTRACT

An echelle grating is used to interleave or de-interleave two combs of signals. In a de-interleaving operation, an optical input signal having a comb of odd channels and an interleaved comb of even channels may be separated into an even-channel optical output signal and an odd-channel optical output signal by an echelle grating. The echelle grating may form an even channel output by diffracting the light in the even channels into respectively different multiple orders at a first angle relative to the input. An odd channel output is formed by diffracting the light in the odd channels into respectively different multiple orders at a second angle that is different from the first angle.

### FIELD OF THE INVENTION

The present invention is directed generally to a fiber optic device, and more particularly to an interleaver for combining and/or separating even and odd sets of optical communication channels.

### BACKGROUND

One of the advantages of optical fiber communication is the potential for large information handling capacity. One approach to increasing the optical bandwidth over which information is transmitted in an optical fiber is to use dense wavelength division multiplexing (DWDM), where light at several different wavelengths is combined and injected into a fiber, the light at each wavelength typically being independently modulated with information prior to combining with the other wavelengths. After propagation through the fiber, the light is then separated into its different wavelength components before detection. The International Telecommunications Union (ITU) has set different DWDM standards that specify the operating wavelengths for the different DWDM components, also known as channels. Under these standards, the separation between adjacent DWDM channels is typically a fixed frequency. For example the inter-channel spacing may be 100 GHZ or 50 GHz.

More information may be transmitted over a fixed bandwidth when the channel separation is smaller, since more channels can fit into the fixed bandwidth. However, it becomes increasingly difficult to multiplex or demultiplex the DWDM channels when the frequency separation is smaller. Components that may be useful for multiplexing and demultiplexing when the channel separation is a given size may not be useful when a smaller channel separation is used. As the pressure for increased fiber information capacity increases, the requirements that optical DWDM components can handle increasingly dense multiplexing also increases.

One approach to producing a smaller channel separation is to create two combs of channels that are separated by twice the desired channel separation, i.e. that have a spacing of 2 Δν. The frequencies of the channels in the first comb are selected to be intermediate the channel frequencies of the second comb. The first comb of frequencies may then be interleaved with the second comb of frequencies, to produce a DWDM signal having a channel spacing of Δν. The device that interleaves the two combs of frequencies is called an interleaver. An advantage provided by an interleaver is that standard DWDM components may be used to generate the different combs of channels, and the addition of the interleaver permits operation at dense multiplexing.

### SUMMARY OF THE INVENTION

There is a need for an optical interleaver that is suitable for operating with fiber optic components. It is desirable that the insertion loss of the interleaver be low and flat across the entire bandwidth of interest. It is also important that the interleaver operates over a wide frequency range and that the cross-talk between channels is low.

According to the invention, an echelle grating may be used to interleave or de-interleave two combs of signals. In a de-interleaving operation, an optical input signal comprising a comb of odd channels and a comb of even channels may be separated into an even-channel optical output signal and an odd-channel optical output signal by an echelle grating with multiple orders that are separated by the frequency separation of the channels in one of the output beams. Such a grating may form an even channel output by diffracting the even channels in multiple orders at a first angle relative to the input. An odd channel output is formed by diffracting the odd channels in multiple orders at a second angle that is different from the first angle.

The echelle grating diffraction efficiency may be large, leading to high interleaver throughput. Crosstalk may also be minimized through optimized grating design.

One particular embodiment of the invention is directed to an optical communication channel interleaver for operating on an optical signal comprising multiple optical channels having odd and even channel frequencies. The optical communications signal has at least one optical beam. The interleaver includes a first port, a second port, and a third port. An echelle grating interleaving unit disposed to diffractively couple light, having even channel frequencies, between the first port and the second port and light, having odd channel frequencies, between the first port and the third port.

Another embodiment of the invention is directed to an optical fiber communications system. The system includes an optical transmitter unit generating light in multiple optical channels having channel frequencies of νₒ+mΔν where νₒ is the lowest frequency, Δν is the channel separation, and m is an integer. The system also includes an optical detector unit detecting signals of the multiple optical channels an optical communications network coupled between the optical transmitter unit and the optical detector unit. The optical communications network includes at least one optical fiber. At least one of the optical transmitter unit and the optical detector unit includes an optical interleaver coupled to the optical communications network. The optical interleaver includes a first port, a second port, and a third port. An echelle grating interleaving unit disposed to diffractively couple light, having even channel frequencies, between the first port and the second port and light, having odd channel frequencies, between the first port and the third port, the interleaver coupled to the optical communications network by the first port and at least one of the second and third ports.

Another embodiment of the invention is directed to a method for de-interleaving an input light beam having a plurality of channel frequencies uniformly spaced by a frequency difference. The method includes directing the input light beam to an echelle grating, and diffracting with the echelle grating odd channel frequencies in a first beam at a first angle to the input light beam and even channel frequencies in a second beam at a second angle to the light beam, the second angle different from the first angle. The method also includes selecting at least one of the odd and even beams as an output beam.

Another embodiment of the invention is directed to a method for interleaving a first beam with odd channel frequencies and a second beam with even channel frequencies to form an output light beam having odd and even channel frequencies uniformly spaced by a frequency difference. The method includes directing the first beam to an echelle grating at a first angle to a grating surface normal and directing the second beam to the echelle grating at a second angle to the grating surface normal, the second angle being different from the first angle. The method also includes diffractively coupling the first beam and the second beam via the echelle grating to an output beam.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a wavelength division multiplexed (DWDM) fiber optics communications system.

FIG. 2A schematically illustrates the deinterelaving of a mixed DWDM input signal to an even channel signal and an odd channel signal by a reflective echelle grating according to the present invention.

FIG. 2B schematically illustrates the diffraction of a mixed DWDM signal to an even channel signal and an odd channel signal by a transmissive echelle grating according to the present invention.

FIG. 3 schematically illustrates front-surface diffraction by a reflective echelle grating.

FIG. 4 is a graph of the diffraction efficiency of an echelle grating as a function of diffraction angle and light frequency.

FIG. 5 schematically illustrates diffraction by a reflective echelle grating in which the light propagates through the grating substrate.

FIG. 6 schematically illustrates diffraction by a transmissive echelle grating in which input light propagates through free space.

FIG. 7 schematically illustrates diffraction by a transmissive echelle grating in which input light propagates through the grating substrate.

FIG. 8 schematically illustrates a single element coupling system for coupling to expanded core waveguide ports.

FIG. 9 schematically illustrates an optical coupling system comprising a lens array and a lens.

FIG. 10 schematically illustrates an optical coupling system comprising a lens array and a faceted beam steering element.

FIG. 11 schematically illustrates an optical interleaver that includes a reflective echelle grating.

FIGS. 12 and 13 schematically illustrate embodiments of optical interleavers that include a transmissive echelle grating.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical fiber systems, and is believed to be particularly suited to interleaving and de-interleaving optical communications channels in a dense wavelength division multiplexed (DWDM) optical communications system.

DWDM systems include several channels of light at different optical frequencies. According to the ITU standards, the channels are evenly spaced by frequency. Thus, the mth channel has a frequency given by νₒ+mΔν, where νₒ is a lowest channel frequency, Δν is the channel separation and m is an integer value ranging from 0 to m₀, the upper value. According to commonly used ITU standards, the channel separation, Δν, may be 100 GHz or 50 GHz., or some other value. Those channels whose frequencies correspond to the even values of m (m=0, 2, 4 . . . etc.) are typically referred to as the even channels, while those channels whose frequencies correspond to the odd values of m (m=1, 3, 5 . . . . etc.) are referred to as the odd channels.

Interleaving is the operation of mixing two signals, one signal containing the even channels and the other signal containing the odd channels, to produce a combined signal containing both the even and odd channels. De-interleaving is the operation of separating a signal containing odd and even channels into a first signal containing the even channels and a second signal containing the odd channels. Many devices used for interleaving may also be used in reverse for de-interleaving. Consequently, the term “interleaving” is often used to denote the operations of interleaving and de-interleaving. Not all interleaving devices are able to perform both interleaving and de-interleaving functions, as is described hereinbelow.

The following discussion describes the different DWDM channels in terms of both frequency and wavelength. It will be appreciated that each channel has a unique wavelength and frequency given through the relationship νₘ·λₘ=c, where λₘ and λₘ are, respectively, the frequency and wavelength of the mth channel, and c is the speed of light.

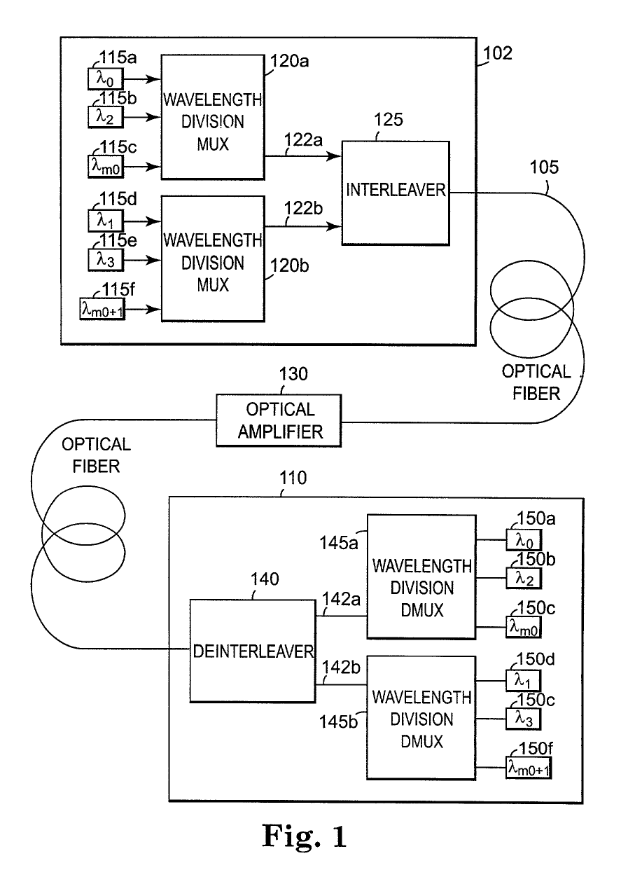

One particular embodiment of a DWDM optical communications system is illustrated in schematic form in FIG. 1. A DWDM transmitter 102 directs a DWDM signal having m₀+1 channels through a fiber communications link 105 to a DWDM receiver 110.

This particular embodiment of DWDM transmitter 102 includes a number of light sources 115a-115c that generate light at different wavelengths, λ₀,λ₂ and λ₂ₙ, corresponding to even optical channels. The light output from the light sources 115a-115c is combined in a first DWDM combiner 120a, to produce a first output 122a. The light in the first output 122a from the first DWDM combiner 120a includes light at the wavelengths λ₀, λ₂ and λ₂ₙ.

The DWDM transmitter 102 also includes other light sources 115d-115f that generate light at a different set of wavelengths, λ₀, λ₃ and λ₂ₙ₊₁ respectively, corresponding to odd optical channels. The light output from the light sources 115d-115f is combined in a second DWDM combiner 120b to produce a second output 122b. The light in the second output 122b from the second DWDM combiner 120b includes light at the wavelengths λ₁, λ₃ and λ₂ₙ₊₁. The inter-channel spacing in each of the first and second outputs 122a and 122b is 2Δν.

The first and second outputs 122a and 122b are combined in the interleaver 125 to produce an interleaved signal containing λ₀, λ₁,λ₂ . . . . λ₂ₙ, at a channel separation of Δν. The interleaved signal is launched into the fiber communications link 105 for propagation to the DWDM receiver 110. Optionally, the fiber communications link 105 may include one or more optical amplifiers 130 to boost the power of the interleaved signal as it propagates from the DWDM transmitter 102 to the DWDM receiver 110.

Light sources 115a-115f may be modulated laser sources, or laser sources whose output is externally modulated, or the like. It will be appreciated that the DWDM transmitter 102 may be configured in many different ways to produce the first and second outputs 122a and 122b that are input to the interleaver 125. For example, other types of coupler may be employed to combine the outputs from light sources than a DWDM coupler. Furthermore, the DWDM transmitter 102 may be equipped with any suitable number of light sources for generating the required number of optical channels. For example, there may be twenty, forty, eighty or more optical channels. The DWDM transmitter 102 may also be redundantly equipped with additional light sources to replace failed light sources.

Upon reaching the DWDM receiver 110, the interleaved signal is passed through a de-interleaver 140, which separates the interleaved signal into an even channel signal 142a, containing the even channels, and an odd channel signal 142b, containing the odd channels. The even channel signal 142a is passed into a first dense wavelength division demultiplexer (WDDM) unit 145a which separates the even channels into individual channels that are directed to respective detectors 150a-150c. Likewise, the odd channel signal 142b is passed into a second WDDM unit 145b that separates the odd channels into individual channels that are directed to respective detectors 150d-150f.

The exemplary DWDM transmitter and receiver architecture illustrated in FIG. 1 permits the user to employ relatively straightforward DWDM components for all multiplexing and demultiplexing operations except for interleaving and de-interleaving. This is advantageous in that the component costs for the transmitter 102 and receiver 110 may be kept low, since only the interleaver and de-interleaver have the requirement of operating at the channel separation Δν, while the other components in the transmitter 102 and receiver 110 typically operate with channels separated by at least 2Δν.

According to the present invention, an echelle grating interleaver may be used to accomplish optical interleaving and optical de-interleaving processes. The echelle grating interleaver typically comprises three fiber coupling ports and an echelle grating interleaving unit that couples an optical signal with even and odd channels to an even channel signal and an odd channel signal. The echelle grating interleaving unit typically includes at least one coupling optical system that couples light from the ports to free space beams that interact with the echelle grating.

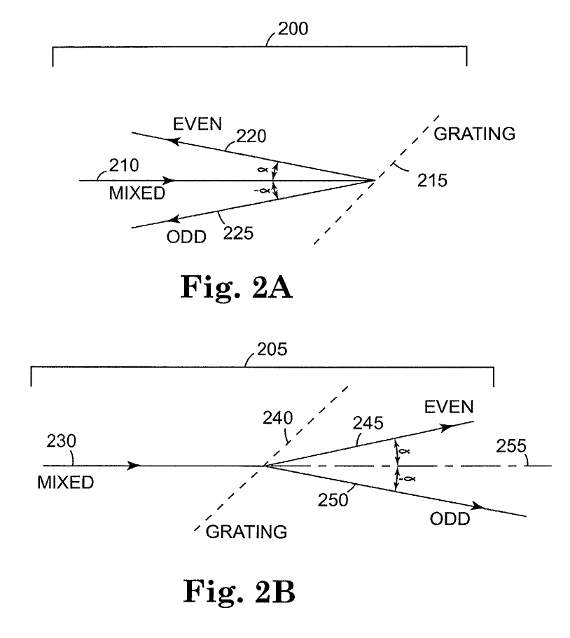

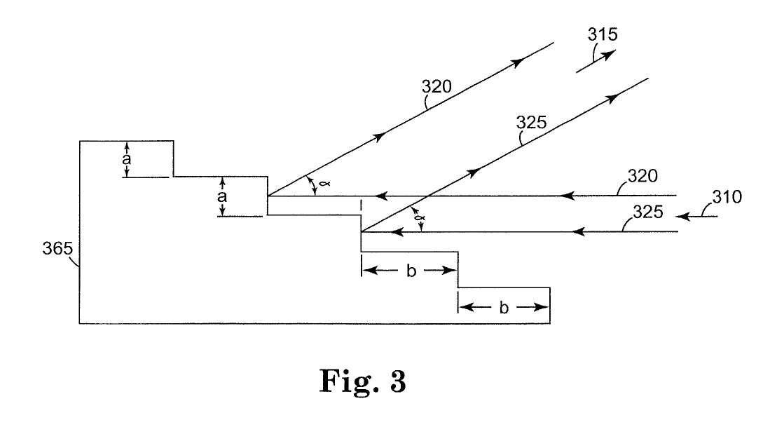

FIG. 2A schematically illustrates the coupling of a substantially collimated input beam comprising even and odd channels to an even channel output beam and an odd channel output beam by a reflective echelle grating. FIG. 2B schematically illustrates the use of a transmission echelle grating for the same purpose. In both FIG. 2A and FIG. 2B, an input beam 210 with mixed odd and even channels is incident on an echelle grating. In FIG. 2A, the light is diffracted from the echelle grating 215 in two beams—an even channel beam 220 and an odd channel beam 225. Typically, the two beams are diffracted on either side of the input beam 210 and may have the same angular separation, α, from the input beam 210. The groove dimensions of the echelle grating 215 are typically chosen in such a way that adjacent channels in the even channel beam 220 correspond to adjacent orders of the echelle grating diffraction pattern. In this fashion, channels having different frequencies may be diffracted at the same angle. Adjacent channels of the odd channel beam may also be diffracted into different grating orders. One odd channel and one even channel are typically diffracted in a single grating order.

A transmission echelle grating may also be used to deinterleave odd and even channels of a mixed input beam. In the deinterleaver 205 of FIG. 2B, the multi-channel input beam 230 is separated into an even channel output beam 245 and an odd channel output beam 250 by the transmission echelle grating 240. The even output beam 245 and the odd output beam 250 may be directed at equal and opposite angles with respect to the direction 255 of the input beam 210. The frequency spacing between diffractive orders of the grating 240 is typically chosen to be equal to the frequency spacing between the even channels. This frequency spacing may be, for example, equal to 100 GHz in a typical DDWDM communications system.

Echelle gratings are distinguished from conventional, echelette gratings by their groove orientation with respect to an incident light beam. Echelle gratings are ruled in such a way that the shorter facet of each grating groove interacts with the input beam(s). Echelette gratings, on the other hand are oriented to diffract light with the longer groove facet. Echelle gratings typically have fewer grooves per millimeter than conventional gratings and are often oriented at a large angle, thereby diffracting light into high diffraction orders. Echelle gratings typically have high efficiencies and minimal polarization anisotropy over a large range of input frequencies. In most cases, they combine high dispersion and resolution. In communications applications, for example, echelle gratings may combine a large diffraction efficiency that is uniform over the operating frequency range of a DWDM communications system with the high dispersion required to completely separate individual channels.

The diffractive properties of an echelle grating are determined by the dimensions of the grating grooves and by the way that the input and output beams interact with the grating. For example, the groove dimensions of a transmission grating designed to deinterleave a multichannel beam with an even channel spacing of 100 GHz are different than the groove dimension of a reflective grating that is designed for the same task. In addition, one or more beams may propagate through a transparent grating substrate.

The invention may be practiced with any echelle grating configuration. For purposes of illustration, however, four exemplary grating designs are described: reflection grating with free space input/output beams; reflection gratings with input/output beams propagating through the substrate; transmission grating with input beam propagating through the substrate; and transmission grating with output beams propagating through the substrate.

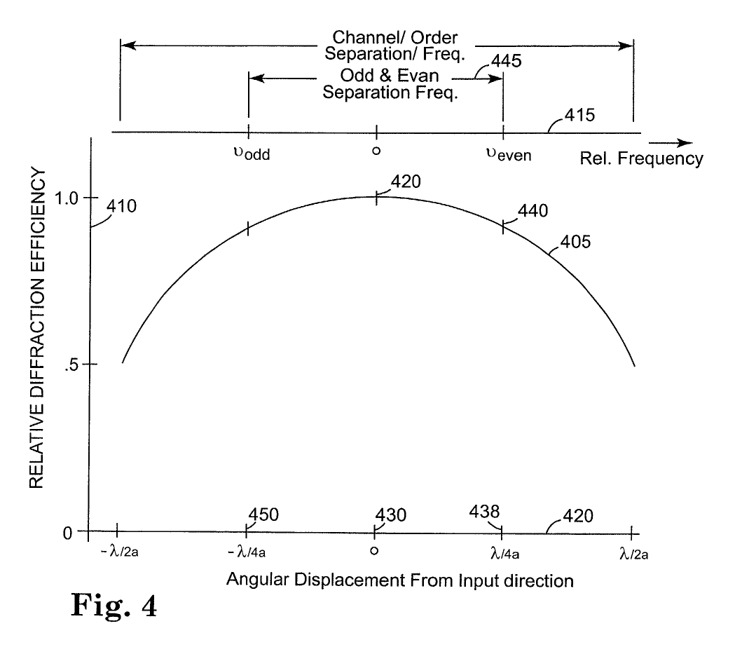

FIG. 3 is a schematic representation of diffraction by an echelle reflection grating with a free space input beam 310 and a free space output beam 315. The grating dimensions are represented by the variable, a, in the short direction and the variable, b, in the long direction. We assume an input frequency, ν, and a spacing between adjacent even channels equal to Δν The angle between the input beam 310 and the output beam 315 is α

Constructive interference occurs when the difference, Δ₁, in the length of the path travelled by the ray 320 and the length of the path travelled by the ray 325 is equal to an integer, m, multiplied by the wavelength, λ, of the light beams 310 and 315. Mathematically, the path length difference, Δ₁, is given by the following expression:

Δ₁=b(1+cos α)−asin α=(m/ν)c (1)

where c is the velocity of light, ν is the light frequency, and m is the diffraction order. This expression may be manipulated in different ways to provide information on the grating design parameters and the angular separation between the input beam 310 and the diffracted beam 315. For example, optical channels that differ in frequency by 100 GHz will be diffracted into multiple orders at the angle, α, if the path length difference, Δ₁, is equal to 2.9979 millimeters. The exact frequency of the input light determines the grating order. For example, optical frequencies commonly used for 1.55 μm communications systems may correspond to diffraction orders near approximately 1934.

The angular separation between adjacent diffraction orders of the grating 305 may be calculated by differentiating Eqn. 1 and it is approximately equal to the ratio of the light wavelength, λ, to the grating dimension, a. Within a given order, the diffraction efficiency of a typical reflective grating may vary between a maximum value of 75% and a minimum value of 37%.

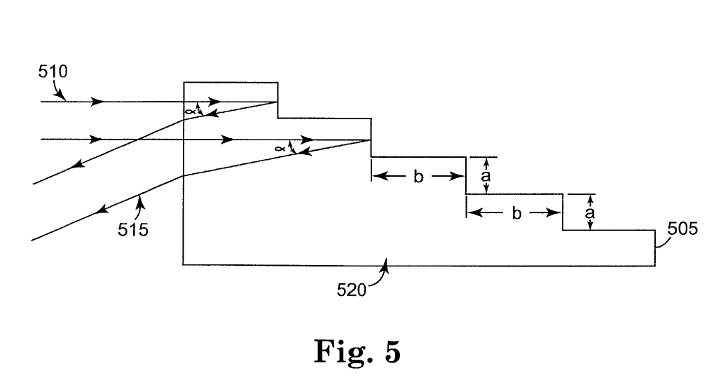

FIG. 4 is a graph of the diffraction efficiency curve 405 of an echelle grating, for example, the echelle grating 305 with a path length, Δ₁, of 2.9979 mm. The vertical axis 410 represents a normalized diffraction efficiency. The upper horizontal axis 415 is the frequency relative to the center of a grating order 420. The lower horizontal axis 425 is the angular displacement from the input beam direction. The center frequency 420 of each diffraction order, is typically diffracted in a direction that is antiparallel to the input beam direction. This direction corresponds to the origin 430 of the lower horizontal axis and the point 435 where the relative frequency is equal to zero.

In an interleaver operation, the approximate frequency spacing between adjacent orders is typically equal to the frequency spacing between adjacent even (odd) channels. For example, the frequency difference between the reflection grating 305 with a path length, Δ₁, of 2.9979 mm is approximately 100 GHz. Even channels with a frequency spacing of approximately 100 GHz are typically diffracted by the grating at a first angle 438 with respect to the input direction. If odd channels are spaced evenly between the even channels, i.e., an odd channel frequency difference of approximately 100 GHz and a frequency difference 445 between odd and even channels of approximately 50 GHz, they will typically be diffracted at a second angle, different from the first angle. In the graph, the even channels and odd channels are diffracted symmetrically with respect to the input beam direction. In this case, the odd channels are typically separated from the input beam direction by an angle of approximately (λ/4a) and the even channels are separated by the same angle on the other side of the input beam direction. The angular separation between the odd and even channel beams is, therefore, equal to approximately (λ/2a).

In each order, the odd channel may be diffracted at an angle of (−λ/4a) and the even channel may be diffracted at an angle of (λ/4a). In FIG. 2A for example, all the odd channels are diffracted in approximately the same direction to form an odd channel output beam 225 and the even channels are diffracted in approximately the same direction to form an even channel output beam 220. In the interleaver operation, the grating dimension, a, is typically chosen in such a way that the odd channel beam 225 and the even channel beam 220 are physically separated from one another and from the input beam by a coupling optical system.

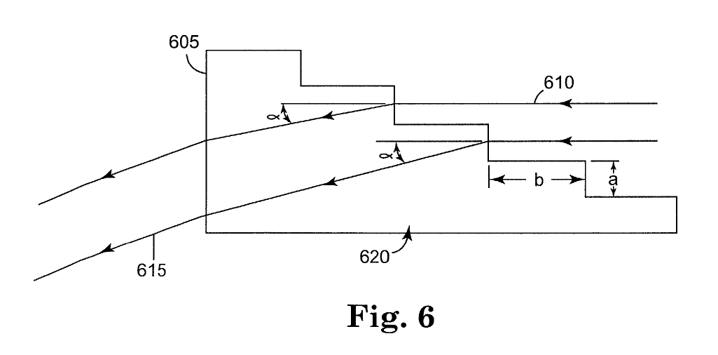

Embodiments of the invention may also use alternative echelle grating designs with dimensions that allow even channels to be diffracted in a first common direction and odd channels to be diffracted a second common direction. For example, FIG. 5 is a schematic representation of a reflective echelle grating in which an input beam 510 and an output beam, 515 propagate through a transparent grating substrate 520. Since the beams are diffracted while propagating through the substrate with index of refraction, n, an alternative expression reflecting the path length difference, Δ₂, must be used. This expression is:

Δ₂=bn(1+cos α)−na sin α=mc/ν=mλ (2)

where b is the ‘long’ dimension and a is the ‘short’ dimension of the grating groove, α is the diffraction angle, n the index of refraction of the substrate, m the grating order, ν the light frequency, c the velocity of light and λ the wavelength of the light.

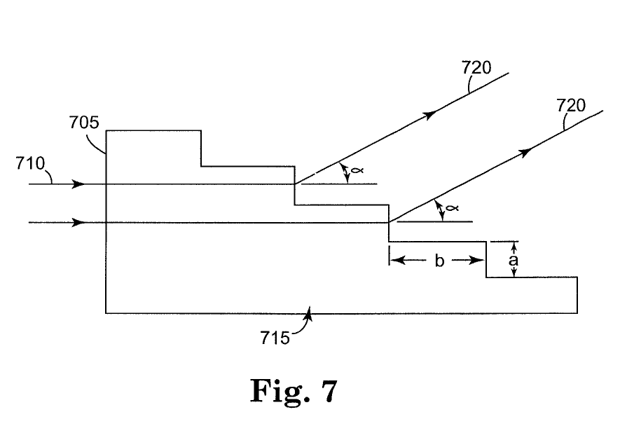

Transmission echelle gratings may also be used to practice the invention. For example, FIG. 6 shows a schematic representation of a transmission echelle grating 605 in which the input beam 610 propagates through air (index of refraction approximately equal to 1) and the diffracted beams 615 propagate through a grating substrate 620 with index of refraction, n. In the case, the optical path length difference, Δ₃, is given by the following expression:

Δ₃=b−bn cos α+an sin α=mc/ν=mλ. (3)

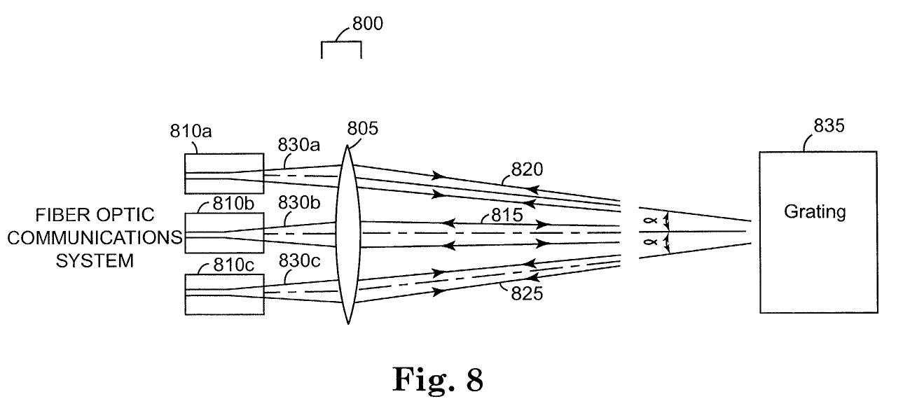

Light may also propagate in the opposite direction through a transmission grating as shown schematically in FIG. 7. In this case, input light propagates through the grating substrate 715 and the diffracted light beams 720 propagate through air. The path length difference, Δ₄, for light diffracted by adjacent grating facets is:

Δ₄=bn−b cos α+a sin α=mλ=mc/ν. (4)

For the grating configurations shown in FIG. 5-FIG. 7, the magnitude of the path length differences corresponding to a particular channel frequency spacing are equal. The expressions that relate the angular difference between channels to the grating dimensions and wavelength may, however, vary with grating configuration. For example, the angular width of a grating order for the gratings of FIG. 5 and FIG. 6 are equal to (1/n)(λ/a) while the angular widths of the grating orders for the gratings of FIG. 3 and FIG. 7 are equal to (λ/a).

An echelle grating interleaver unit typically includes an echelle grating and an optical system. The echelle grating typically interacts with free space beams that are coupled to a set of fiber optic ports by the optical coupling system. The free space beams may be substantially collimated at the grating and the odd-channel beam and the even channel beam are typically angled with respect to the mixed channel beam. The optical coupling system may advantageously combine high coupling efficiency with small size, ease of alignment and low cost.

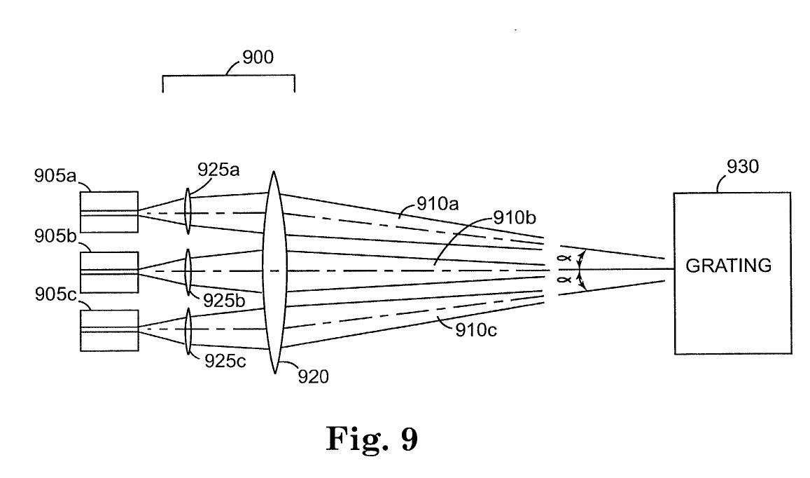

FIG. 8 is a schematic representation of an optical coupling system comprising a single focusing element 805. A mixed channel free space beam 815 is typically coupled to an even channel free space beam 820 and an odd channel free space beam 825 by an echelle grating 835. The optical ports 810a-810c may typically include expanded-mode waveguides for high efficiency coupling to the free space beams 830a-830c.

The free space beams 830a-830c typically have divergence angles that are small in comparison to free space beams that are coupled to conventional single-mode waveguides.

The single focusing element 805 may comprise a lens, a diffractive optic or other element that can couple the beams 830a-830c to the beams 815-825.

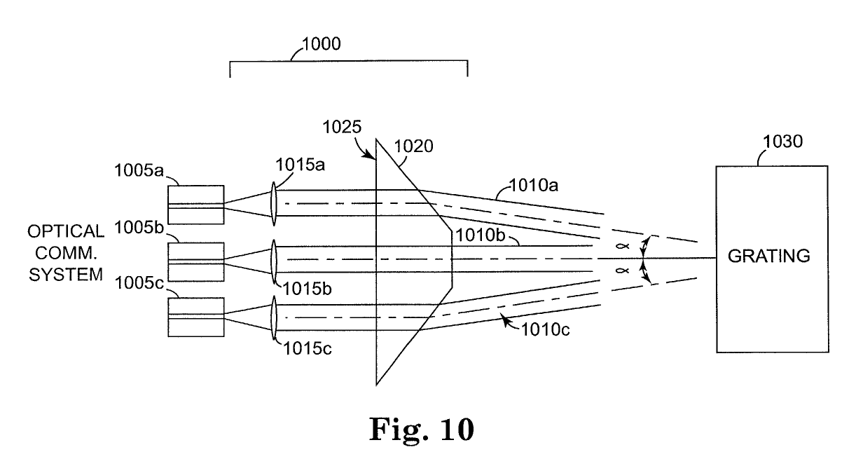

FIG. 9 schematically illustrates an optical system 900 for coupling light from the conventional waveguide ports 905a-905c to the free space beams 910a-910c. The optical coupling system 900 comprises a focusing element 920 that may be a conventional or diffractive optical element and an array of lenses 925a-925c. The lenses 925a-925c may, for example, be conventional lenses, molded lenses, gradient index lenses or a microlens array. The lenses 925a-925c typically have a large numerical aperture and may be separated from the ports 905a-905c by a distance that is less that the focal length of the lenses 925a-925c. An echelle grating 930 may couple the beam 910b to the beams 910a and 910c.

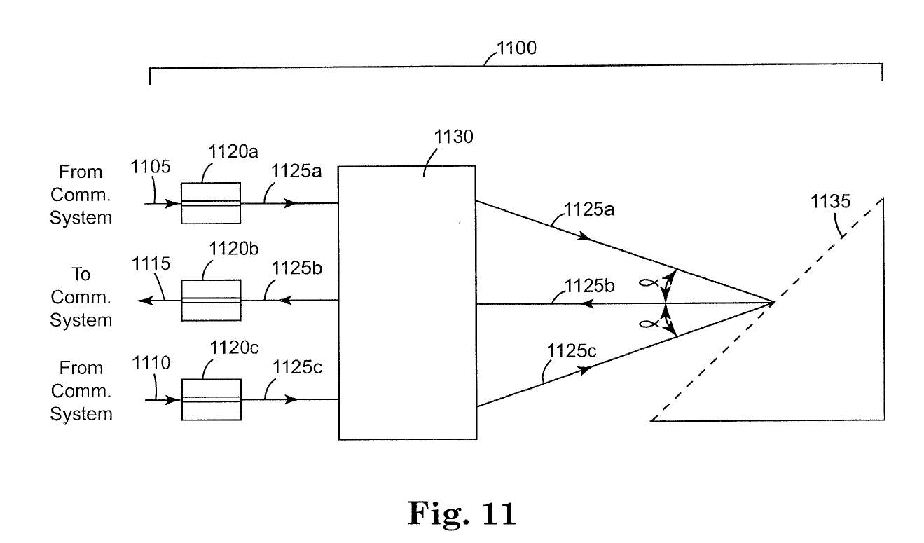

FIG. 10 schematically illustrates an alternative optical system 1000 for coupling light from the conventional waveguide ports 1005a-1005c to the free space beams 1010a-1010c. The lenses 1015a-1015c may, for example, be conventional lenses, molded lenses, gradient lenses or a microlens array. The distance of the lenses 1015a-1015c from the conventional waveguide ports is typically selected to substantially collimate the free space beams 1010a-1010c and the free space beams 1010a-1010c may be substantially collimated at the large facet 1025 of the faceted beam steerer 1020. The beam steering element 1020 typically redirects the beams 1010a and 1010c at equal and opposite angles to the beam 1010b. The direction of the beam 1010b is typically unchanged by the faceted beam steering element 1020. An echelle grating 1030 may couple the beam 1010b to the beams 1010a and 1010c.

The coupling optical system 1000 may also be used to couple fewer than three ports to free space beams. For example, the ports 1005a and 1005c may be coupled to the free space beams 1010a and 1010c. In this case, the operation of the optical system 1000 would be illustrated by removing the port 1005b, the lens 1015b and the free space beam 1020b from the diagram of FIG. 10. Optionally, the faceted beam steering element 1020 may be a simple three-side prism.

The optical coupling systems 800 and 900 may also operate as single-port or two-port couplers. Single-port and two-port operation are useful with transmission echelle grating interleavers. FIG. 8 and FIG. 9 may be modified to single-port and two-port operation by eliminating the appropriate elements from the diagrams. For example, two-port operation of the coupling system 800 may obtained with the port 810b, the diverging beam 830b and the substantially collimated beam 815 removed. Single-port operation may similarly be obtained by removing the ports 810a, 810c, the diverging beams 830a, 830c and the substantially collimated beams 820 and 825.

Two-port operation of the coupling system 900 may also be illustrated by similar modifications to the schematic diagram of FIG. 9. For example, two-port operation may be obtained by removing the port 905b, the lens 925b and the free space beam 910b. Single port operation may be obtained by removing the ports 905a, 905c, the lenses 925a, 925c and the free space beams 910a, 910c.

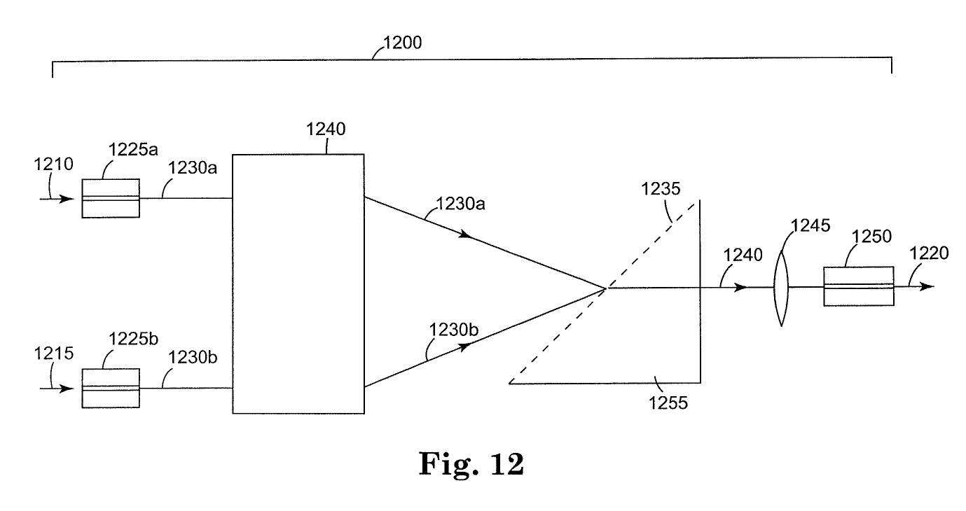

Embodiments of the invention may comprise an echelle grating interleaver unit that includes a grating and a optical coupling system and a set of ports that couple the interleaver unit to a fiber optic communication system. FIG. 11 schematically illustrates one embodiment of an optical communications interleaver according to the invention that couples an even channel signal 1105 and an odd channel signal 1110 to an mixed signal 1115. The signals are typically transported to the interleaver input/output ports 1120a-1120c by optical fibers. The port 1120a couples the even channel input beam 1105 to the free space beam 1125a. Similarly, the port 1120c couples the odd channel input signal 1110 to the free space beam 1125c. The free space beams 1125a and 1125c are substantially collimated and redirected towards the echelle grating 1135 by the optical coupling unit 1130. The optical coupling unit may, for example, have a design similar to the coupling unit 900 of FIG. 9 or the coupling unit 1000 of FIG. 10. In an alternative embodiment, the ports 1120a-1120c have expanded mode waveguides and the optical coupling system 1130 may be a single lens coupling system 800.

In the embodiment of FIG. 11, the echelle grating is oriented with the reflective surface adjacent to the optical coupling system. The beams 1125a and 1125c are diffracted as shown in FIG. 3 and the echelle grating is designed to couple the beams 1125a and 1125c to the beam 1125b. The mixed channel beam 1125b typically propagates through optical coupling system without deviation and is coupled to the output beam 1115 by the port 1120b. In an alternative embodiment, the grating 1135 may have a transparent substrate and be oriented so that the beams 1125a-1125c propagate through the transparent substrate and are diffracted as illustrated in FIG. 5.

The optical communications interleaver, 1100 may be operated as an optical communications deinterleaver by reversing the propagation direction of the light beams in FIG. 11. In a deinterleaver operation, the signal 1115 and the free space beam 1125b would propagate towards the grating 1135 while the signals 1105 and 1110 and the free space beams 1125a and 1125c would propagate away from the grating.

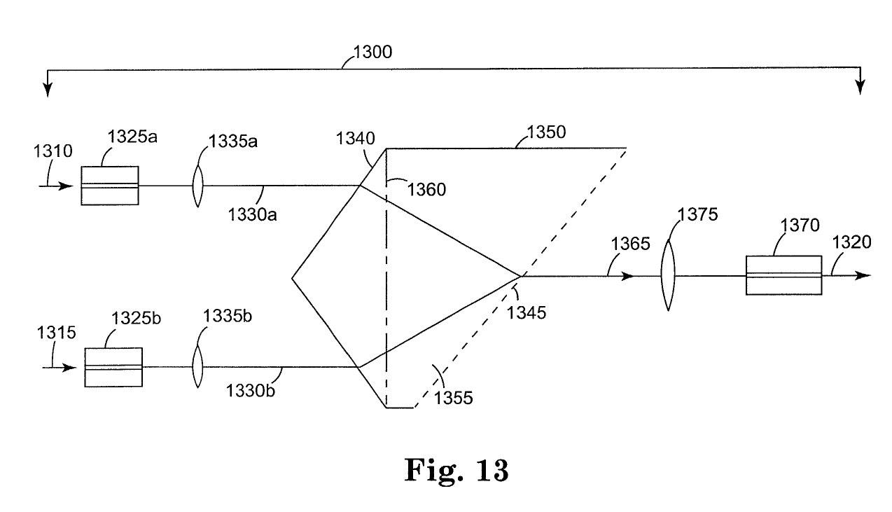

FIG. 12 is a schematic representation of another embodiment of an optical communications interleaver 1200 according to the invention. The interleaver 1200 may combine an odd input signal 1210 and an even input signal 1215 to form a mixed output signal 1220 that typically includes a mixture of odd and even channels. The odd channel input 1210 and the even channel input 1215 are typically coupled to the ports 1225a, 1225b. The ports 1225a, 1225b are typically designed to couple the input signals 1210, 1215 to free space beams 1230a, 1230b that may be collimated and directed towards the transmission echelle grating 1235 by the optical coupling system 1240. The optical coupling system may be one of the optical coupling systems shown in FIG. 8, FIG. 9, and FIG. 10 and will typically be modified to function as a two-beam coupler.

The echelle grating 1235 diffracts the beams 1230a, 1230b to form the mixed channel beam 1240. A single focusing element typically couples the free space beam 1240 to the output port 1250. The transmission echelle grating 1235 may be oriented so the beams 1230a and 1230b pass through the grating substrate 1255 or, alternatively, it may be oriented so that the output beam 1240 passes through the substrate. Expression (4) describes the constructive interference condition for the grating orientation shown in FIG. 12 while expression (3) is the corresponding relation for a transmission grating oriented in such a way that the output beams pass through the substrate.

FIG. 13 presents a schematic representation of another embodiment of an optical communications interleaver 1300 according to the invention. The interleaver 1300 combines an odd input signal 1310 and an even input signal 1315 to form a mixed output signal 1320. The odd channel input signal 1310 and the even channel input signal 1315 are typically coupled to the ports 1325a, 1325b, which are designed to couple the input signals 1310, 1315 to free space beams 1330a, 1330b that are collimated by the optical focusing elements 1335a, 1335b. The propagation directions of the free space beams 1330a and 1330b are changed by the faceted beam steering element 1340 in such a way that the beams 1330a and 1330b intersect at the surface 1345 of the transmission echelle grating 1350. The faceted beam steering element 1340 may be attached to the rear surface 1360 of the transmission grating substrate 1355 or integrally formed with the grating substrate 1355.

The free space beams 1330a and 1330b are typically diffracted by the transmission grating 1350 to form a mixed signal beam 1365 that is coupled to the port 1370 by the focusing element 1375. The focusing elements 1335a, 1335b, and 1375 may, for example, be simple lenses, molded lenses, diffractive focusing elements, or gradient index lenses.

The optical interleaver 1300 offers the advantages of reduced part count and ease of alignment when compared to optical interleavers with more complex optical coupling systems. These advantages may also be obtained in a reflective grating embodiment including a reflective grating 505. In this case, a faceted beam steering element may be attached to or integrally formed with a reflective grating 505. Deinterleaving operation of the interleaver 1300 may be obtained by reversing the direction of propagation of the signals 1310, 1315 and 1320.

The present invention is applicable to optical communications systems and is believed to be particularly useful in interleaving optical signals in a DWDM communications network. Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification.

We claim:

1. An optical communication channel interleaver for operating on an optical signal comprising multiple optical channels having odd and even channel frequencies, the optical communications signal comprising at least one optical beam, the interleaver comprising:
a first port;
a second port;
a third port;
an echelle grating interleaving unit disposed to diffractively couple light, having even channel frequencies, between the first port and the second port and light, having odd channel frequencies, between the first port and the third port.

2. An interleaver as recited in claim 1, the echelle grating interleaving unit including an optical coupling system disposed between an echelle grating and the first port and at least one of the second and third ports to couple light between the first port and at least one of the second and third ports, via the echelle grating.

3. An interleaver as recited in claim 2, wherein the optical coupling system includes a lens array and an optical focusing element.

4. An interleaver as recited in claim 3, wherein the lens array includes individual focusing elements associated with respective ports.

5. An interleaver as recited in claim 4, wherein the individual focusing elements in the lens array are positioned to couple light in the ports to substantially collimated beams.

6. An interleaver as recited in claim 3, wherein the echelle grating includes a transparent substrate and light propagating between the first port and at least one of the second and third ports passes through the substrate.

7. An interleaver as recited in claim 2. wherein the optical coupling system includes a faceted beam steering element and an optical focusing element.

8. An interleaver as recited in claim 6, wherein the echelle grating includes a transparent substrate and the light passes through the substrate.

9. An interleaver as recited in claim 8, wherein the faceted beam steering element is attached to the substrate.

10. An interleaver as recited in claim 8, wherein the faceted beam steering element is integrally formed with the substrate.

11. An interleaver as recited in claim 2, wherein the echelle grating has a reflective diffractive surface.

12. An interleaver as recited in claim 1, the echelle grating interleaving unit including a first optical coupling system disposed between the first port and the echelle grating and a second optical coupling system disposed between the grating and at least one of the second and third ports, the first and second optical coupling systems coupling light propagating between the first and at least one of the second and third ports, via the echelle grating.

13. An interleaver as recited in claim 12, wherein the first optical coupling system is a lens.

14. An interleaver as recited in claim 12, wherein the second optical coupling system includes a lens array and an optical focusing element.

15. An interleaver as recited in claim 14, wherein the lens array includes individual focusing elements associated with the second and third ports.

16. An interleaver as recited in claim 15, wherein the individual focusing elements in the lens array are positioned to couple light in the second and third ports to substantially collimated beams.

17. An interleaver as recited in claim 12, wherein the echelle grating includes a transparent substrate and the light coupled between the first port and at least one of the second and third ports passes through the substrate.

18. An interleaver as recited in claim 17 wherein the second optical coupling system includes a faceted beam steering element and an optical focusing element.

19. An interleaver as recited in claim 18, wherein the faceted beam steering element is attached to the substrate.

20. An interleaver as recited in claim 18, wherein the faceted beam steering element is integrally formed with the substrate.

21. An interleaver as recited in claim 17, wherein the echelle grating is oriented with a diffractive surface nearest the first port.

22. An interleaver as recited in claim 17, wherein the echelle grating is oriented with a diffractive surface nearest the second and third ports.

23. An interleaver as recited in claim 1, wherein the even-channel light is diffracted in a first direction and the odd-channel light is diffracted in a second direction different from the first direction.

24. An interleaver as recited in claim 23, wherein the first direction and the second direction form an angle at the echelle grating that is bisected by an optical axis.

25. An interleaver as recited in claim 23, wherein light coupled to the first port propagates in a direction that is parallel to the optical axis at the grating.

26. An interleaver as recited in claim 1, wherein different even channels are diffracted in respectively different diffractive orders.

27. An interleaver as recited in claim 26, wherein different odd channels are diffracted in respectively different diffractive orders.

28. An optical fiber communications system, comprising:
an optical transmitter unit generating light in multiple optical channels having channel frequencies of νₒ+mΔν where νₒ is the lowest frequency,
Δν is the channel separation, and m is an integer;
an optical detector unit detecting signals of the multiple optical channels; and
an optical communications network coupled between the optical transmitter unit and the optical detector unit, the optical communications network including at least one optical fiber;
wherein at least one of the optical transmitter unit and the optical detector unit includes an optical interleaver coupled to the optical communications network, the optical interleaver comprising
a first port;
a second port;
a third port;
an echelle grating interleaving unit disposed to diffractively couple light, having even channel frequencies, between the first port and the second port and light, having odd channel frequencies, between the first port and the third port, the interleaver coupled to the optical communications network by the first port and at least one of the second and third ports.

29. An optical fiber communications system as recited in claim 28, further comprising at least one optical amplifier disposed in at least one of the optical transmitter unit, the optical network and the optical detector unit.

30. An optical fiber communications system as recited in claim 28, wherein the first port is coupled to receive multi-channel light from the optical transmitter unit and at least one of the second and third ports is coupled to transmit an output light beam for detection within the optical detection unit.

31. A system as recited in claim 30, wherein the optical detector unit includes a plurality of optical detectors for detecting light having different channel frequencies and at least one wavelength division demultiplexing element disposed between at least one of the second port and the third port and the plurality of optical detectors to direct light from the interleaver to the plurality of optical detectors.

32. A system as recited in claim 28, wherein the second port is coupled to receive light from an even-channel transmitter, the third port is coupled receive light from an odd-channel transmitter, and the first port is coupled to transmit a multi-channel light beam.

33. A system as recited in claim 32, wherein at least one of the even channel transmitter and the odd channel transmitter includes a plurality of light sources to generate light beams at the optical channel frequencies and at least one wavelength division multiplexing element being coupled between the plurality of light sources and the interleaver to direct at least two beams to the interleaver.

34. A system as recited in claim 28, wherein light having different even channel frequencies is diffracted by the echelle grating interleaving unit in respectively different diffraction orders.

35. A system as recited in claim 34, wherein light having different odd channel frequencies is diffracted by the echelle grating interleaving unit in respectively different diffraction orders.

36. A method for de-interleaving an input light beam having a plurality of channel frequencies uniformly spaced by a frequency difference, comprising:
directing the input light beam to an echelle grating;
diffracting with the echelle grating odd channel frequencies in a first beam at a first angle to the input light beam and even channel frequencies in a second beam at a second angle to the light beam, the second angle different from the first angle; and
selecting at least one of the odd and even beams as an output beam.

37. A method as recited in claim 36, wherein the echelle grating is a transmission grating.

38. A method as recited in claim 36, including passing at least one of the input beam, the first beam, and the second beam propagates through a grating substrate.

39. A method as recited in claim 36, wherein the grating is a reflection grating.

40. A method as recited in claim 36, including coupling the input beam to a first port, the first beam to a second port, and the second beam to a third port with an optical focusing system.

41. A method as recited in claim 36, including coupling the input beam to a first port with a first optical focusing system and coupling, with a second optical system, the first beam to a second port and the second beam to a third port.

42. A method as recited in claim 36 including bending the first beam and the second beam with a faceted beam steering element.

43. A method as recited in claim 36, wherein light in the first beam at different odd channel frequencies is diffracted by the echelle grating into respectively different diffraction orders.

44. A method as recited in claim 36, wherein light in the first beam at different even channel frequencies is diffracted by the echelle grating into respectively different diffraction orders.

45. A method for interleaving a first beam with odd channel frequencies and a second beam with even channel frequencies to form an output light beam having odd and even channel frequencies uniformly spaced by a frequency difference, comprising:
directing the first beam to an echelle grating at a first angle to a grating surface normal;
directing the second beam to the echelle grating at a second angle to the grating surface normal, the second angle being different from the first angle;
diffractively coupling the first beam and the second beam via the echelle grating to an output beam.

46. A method as recited in claim 45, including propagating at least one of the first beam, the second beam and the output beam through a grating substrate.

47. A method as recited in claim 45, wherein the echelle grating is a transmission grating.

48. A method as recited in claim 45, wherein the echelle grating is a reflection grating.

49. A method as recited in claim 45, including coupling the output beam to a first port, the first beam to a second port and the second beam to a third port with an optical focusing system.

50. A method as recited in claim 45, including coupling the output beam to a first port with a first optical focusing system and coupling, with a second optical system, the first beam to a second port and the second beam to a third port.

51. A method as recited in claim 45, including bending the first beam and the second beam with a faceted beam steering element.
